(19) United States
(12) Patent Application Publication
(10) Pub. No.: US 2016/0347147 A1
(43) Pub. Date: Dec. 1, 2016

(54) VEHICLE CAB

(71) Applicant: Deere & Company, Moline, IL (US)

(72) Inventors: Ralf Ehricht, Weinheim (DE); Corinna Jurzok, Kaiserslautern (DE); Phouphadeth Sananikone, Ludwigshafen (DE); Alexander Berg, Mannheim (DE)

(21) Appl. No.: 15/160,497

(22) Filed: May 20, 2016

(30) Foreign Application Priority Data
May 26, 2015 (DE) 102015209581.9

(51) Int. Cl. B60H 1/00; F01N 3/02; B60H 1/24; B62D 33/06

(52) U.S. Cl. CPC B60H 1/00378; B62D 33/0617; F01N 3/0205; B60H 1/248; F01N 2610/02

(57) ABSTRACT

A vehicle cab includes a climate control unit for an agricultural working vehicle. The climate control unit supplies a quantity of air that is conditioned by means of the climate control unit, at least with respect to temperature, into a space of the vehicle cab. The vehicle cab also includes an exhaust air path associated with the space in order to remove a quantity of exhaust air from the space of the vehicle cab.

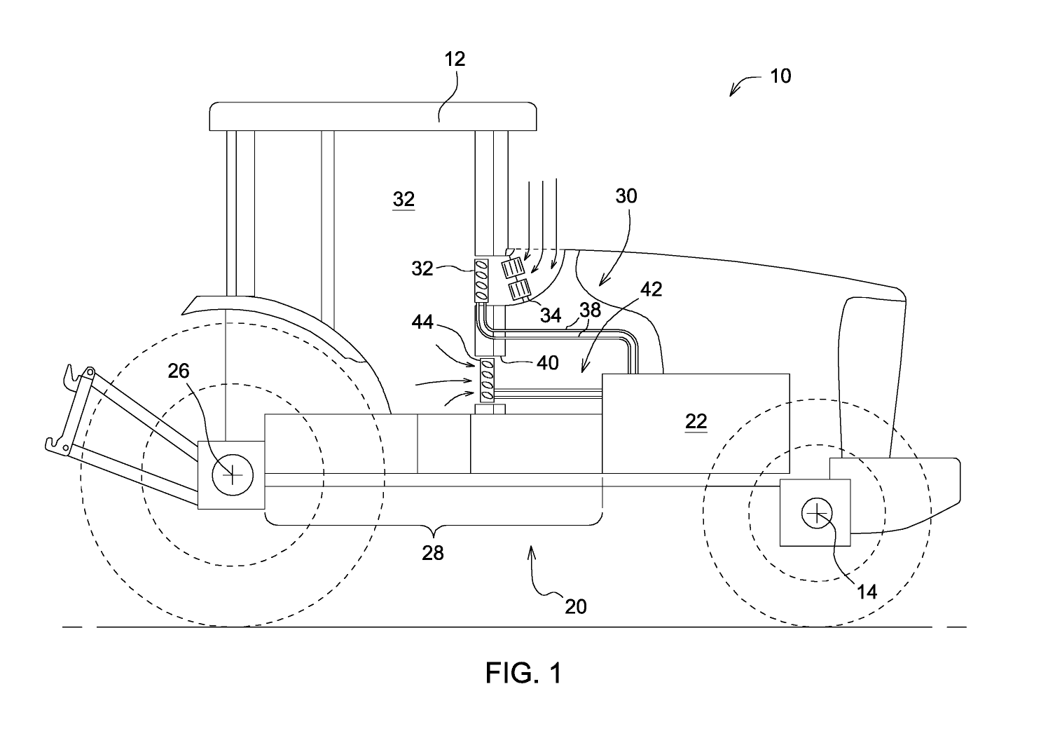

### RELATED APPLICATION

This application claims the benefit of German Application Ser. No. 102015209581.9, filed on May 26, 2015, which is hereby expressly incorporated by reference in its entirety.

### FIELD OF THE DISCLOSURE

The disclosure relates to a vehicle cab having a climate control unit in order to supply a quantity of air that is conditioned by means of the climate control unit, at least with respect to temperature, into a space of the vehicle cab and having an exhaust air path associated with the space in order to remove a quantity of exhaust air from the space of the vehicle cab.

### BACKGROUND

Vehicle cabs, e.g., those of agricultural working vehicles in the form of tractors, are currently generally equipped with climate control units in order to control the temperature of the space in the vehicle cab to a temperature that is comfortable for the operator. Controlling the temperature of the space initially includes cooling, since either the exterior temperature is at a level that results in an interior temperature at a level that is no longer acceptable to an operator, or heating inside the cab as a consequence of solar irradiation of the cab that leads to a temperature level that is also no longer acceptable. Controlling the temperature of the space can further include heating as well.

Temperature control for cooling is fundamentally very energy-intensive, since a refrigerant circuit must be maintained in which a refrigerant compressor driven by a drive motor must compress a refrigerant in order then to expand the refrigerant at an appropriate point and thereby withdraw heat from the surroundings. It is generally the case that the temperature of the space in the vehicle cab is controlled to a range of 20-25° C. Since a quantity of air that has been temperature-controlled to a markedly cooler temperature must be continuously fed into the space in the vehicle cab for this purpose, there is at least a slight overpressure in the vehicle cab relative to the surroundings. In addition, exhaust air escapes from the space, either via a leak already present in the body shell of the vehicle cab or via a defined exhaust air path in the body shell of the vehicle cab. Thus, air that has previously been controlled with expenditure of energy to a temperature range of 20-25° C. escapes unused into the surroundings.

Moreover, current agricultural working machines have additional cooling devices with which, for example, fuel systems or supply systems for additives that are supplied to the exhaust system are cooled. Finally, there are generally multiple electronic components in the form of control devices, which likewise require cooling and, in the simplest case, have ribbed cooling elements.

### SUMMARY

In the present disclosure, one or more embodiments of a vehicle cab are described as being capable of not discharging an exhaust air stream unused into the environment.

In one embodiment, a vehicle cab of an agricultural working vehicle has a climate control unit in order to supply a quantity of air that is conditioned by means of the climate control unit, at least with respect to temperature. The air is supplied into a space of the vehicle cab. The cab further includes an exhaust air path associated with the space in order to remove a quantity of exhaust air from the space of the vehicle cab. A heat exchanger of a cooling device for diverting a quantity of heat is arranged in the exhaust air path, and the exhaust air quantity is applied to the heat exchanger in order to emit a quantity of heat from the cooling device.

In this disclosure, it is possible to further utilize the exhaust air that has been temperature-controlled by the climate control device, more particularly, by making this exhaust air available to a cooling device present on the working vehicle.

In one possible embodiment, the cooling device is a cooling element of an electrical component. In a further embodiment, the entire electrical component can be arranged with the cooling element in the exhaust air path and the exhaust air quantity can be applied thereto for cooling. Alternatively, it can be provided that the exhaust air quantity is only applied to the cooling element.

In another embodiment, the cooling device is a cooling circuit for a fuel system or a supply device for urea.

### BRIEF DESCRIPTION OF THE DRAWING

The above-mentioned aspects of the present disclosure and the manner of obtaining them will become more apparent and the disclosure itself will be better understood by reference to the following description of the embodiments of the disclosure, taken in conjunction with the accompanying drawings, wherein:

The FIGURE illustrates an embodiment of an agricultural working vehicle having a drivetrain.

### DETAILED DESCRIPTION

In one embodiment, the FIGURE shows an agricultural working vehicle 10 in the form of a tractor having a drivetrain 20. The working vehicle 10 further includes a vehicle cab 12, a front vehicle axle 14 and a rear vehicle axle 26. The vehicle cab 12 encloses or defines a space 36 therein. The drivetrain 20 further includes a drive motor 22, which can be embodied as an internal combustion engine, and a transmission structure 28.

The vehicle cab 12 also includes a climate control device 30 having an evaporator 32 to which ambient air is applied via a fresh air fan 34 and which is arranged in the region of the vehicle cab 12. In addition, a heat exchanger (not shown) may be provided to heat the incoming ambient air. The evaporator 32 is connected via a refrigerant-conducting line to additional components of the climate control device 30 that are arranged in the vicinity of the drive motor such as, for example, a refrigerant compressor, a refrigerant condenser and a filter dryer.

In the present embodiment, an exhaust air path 40 is arranged in a front, lower region of the vehicle cab 12, but may also be arranged at a different location in the vehicle cab 12 if necessary. The exhaust air path 40 is used firstly to remove a quantity of exhaust air from the space 36 depending on the quantity of air supplied via the fresh air fan 34 from the surroundings. The opening cross-section of the exhaust air path 40 can be adapted such that a defined overpressure relative to the surroundings may be set in the vehicle when the fresh air fan 34 is in its low-power stage.

While embodiments incorporating the principles of the present disclosure have been described hereinabove, the present disclosure is not limited to the described embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A vehicle cab of an agricultural working vehicle, comprising:
a climate control unit configured to supply a quantity of air that is conditioned by means of the climate control unit with respect to temperature into a space defined by the vehicle cab; and
an exhaust air path associated with the defined space for removing a quantity of exhaust air from the space of the vehicle cab;
wherein a heat exchanger of a cooling device for dissipating a quantity of heat is arranged in the exhaust air path, and the exhaust air quantity is applied to the heat exchanger in order to emit a quantity of heat from the cooling device.

2. The vehicle cab of claim 1, wherein the cooling device is a cooling element of an electrical component.

3. The vehicle cab of claim 1, wherein the cooling device is a cooling circuit of a fuel system or of a supply device for urea.
